(19) United States
(12) Patent Application Publication
(10) Pub. No.: US 2011/0220083 A1
(43) Pub. Date: Sep. 15, 2011

(54) SPLIT-CYCLE ENGINE HAVING A CROSSOVER EXPANSION VALVE FOR LOAD CONTROL

(75) Inventors: Riccardo Meldolesi, Shoreham-by-Sea (GB); Nicholas Badain, Shoreham-by-Sea (GB); Ian Gilbert, Shoreham-by-Sea (GB); Ford Phillips, San Antonio, TX (US)

(73) Assignee: Scuderi Group, LLC, West Springfield, MA (US)

(21) Appl. No.: 13/046,840

(22) Filed: Mar. 14, 2011

Related U.S. Application Data
(60) Provisional application No. 61/313,831, filed on Mar. 15, 2010.
(60) Provisional application No. 61/363,825, filed on Jul. 13, 2010.
(60) Provisional application No. 61/365,343, filed on Jul. 18, 2010.
(60) Provisional application No. 61/404,239, filed on Sep. 29, 2010.

(51) Int. Cl. F02B 33/22

(52) U.S. Cl. 123/70 R

(57) ABSTRACT

An engine includes a crankshaft rotatable about a crankshaft axis. A compression piston is slidably received within a compression cylinder and operatively connected to the crankshaft. An expansion piston is slidably received within an expansion cylinder and operatively connected to the crankshaft. A crossover passage interconnects the compression and expansion cylinders. The crossover passage includes a crossover expansion (XovrE) valve disposed therein. In at least one of an Engine Firing (EF) mode, an Firing and Charging (FC) mode, and an Air Expander and Firing (AEF) mode of the engine, the timing of the XovrE valve closing is variable to control engine load, and the engine has a residual expansion ratio at XovrE valve closing of 14 to 1 or greater.

### CROSS-REFERENCE TO RELATED APPLICATIONS

This application claims the priority of U.S. Provisional Application No. 61/313,831 filed Mar. 15, 2010, U.S. Provisional Application No. 61/363,825 filed Jul. 13, 2010, U.S. Provisional Application No. 61/365,343 filed Jul. 18, 2010, and U.S. Provisional Application No. 61/404,239 filed Sep. 29, 2010.

### TECHNICAL FIELD

This invention relates to split-cycle engines and, more particularly, to such an engine having a crossover expansion valve for load control and optionally incorporating an air-hybrid system.

### BACKGROUND OF THE INVENTION

For purposes of clarity, the term “conventional engine” as used in the present application refers to an internal combustion engine wherein all four strokes of the well-known Otto cycle (i.e., the intake (or inlet), compression, expansion (or power) and exhaust strokes) are contained in each piston/cylinder combination of the engine. Each stroke requires one half revolution of the crankshaft (180 degrees crank angle (CA)), and two full revolutions of the crankshaft (720 degrees CA) are required to complete the entire Otto cycle in each cylinder of a conventional engine.

Also, for purposes of clarity, the following definition is offered for the term “split-cycle engine” as may be applied to engines disclosed in the prior art and as referred to in the present application.

A split-cycle engine as referred to herein comprises:

a crankshaft rotatable about a crankshaft axis;

a compression piston slidably received within a compression cylinder and operatively connected to the crankshaft such that the compression piston reciprocates through an intake stroke and a compression stroke during a single rotation of the crankshaft;

an expansion (power) piston slidably received within an expansion cylinder and operatively connected to the crankshaft such that the expansion piston reciprocates through an expansion stroke and an exhaust stroke during a single rotation of the crankshaft; and

a crossover passage (port) interconnecting the compression and expansion cylinders, the crossover passage including at least a crossover expansion (XovrE) valve disposed therein, but more preferably including a crossover compression (XovrC) valve and a crossover expansion (XovrE) valve defining a pressure chamber therebetween.

U.S. Pat. No. 6,543,225 granted Apr. 8, 2003 to Scuderi and U.S. Pat. No. 6,952,923 granted Oct. 11, 2005 to Branyon et al., both of which are incorporated herein by reference, contain an extensive discussion of split-cycle and similar-type engines. In addition, these patents disclose details of prior versions of an engine of which the present disclosure details further developments.

Split-cycle air-hybrid engines combine a split-cycle engine with an air reservoir and various controls. This combination enables a split-cycle air-hybrid engine to store energy in the form of compressed air in the air reservoir. The compressed air in the air reservoir is later used in the expansion cylinder to power the crankshaft.

A split-cycle air-hybrid engine as referred to herein comprises:

a crankshaft rotatable about a crankshaft axis;

a compression piston slidably received within a compression cylinder and operatively connected to the crankshaft such that the compression piston reciprocates through an intake stroke and a compression stroke during a single rotation of the crankshaft;

an expansion (power) piston slidably received within an expansion cylinder and operatively connected to the crankshaft such that the expansion piston reciprocates through an expansion stroke and an exhaust stroke during a single rotation of the crankshaft;

a crossover passage (port) interconnecting the compression and expansion cylinders, the crossover passage including at least a crossover expansion (XovrE) valve disposed therein, but more preferably including a crossover compression (XovrC) valve and a crossover expansion (XovrE) valve defining a pressure chamber therebetween; and

an air reservoir operatively connected to the crossover passage and selectively operable to store compressed air from the compression cylinder and to deliver compressed air to the expansion cylinder.

U.S. Pat. No. 7,353,786 granted Apr. 8, 2008 to Scuderi et al., which is incorporated herein by reference, contains an extensive discussion of split-cycle air-hybrid and similar-type engines. In addition, this patent discloses details of prior hybrid systems of which the present disclosure details further developments.

A split-cycle air-hybrid engine can be run in a normal operating or firing (NF) mode (also commonly called the Engine Firing (EF) mode) and four basic air-hybrid modes. In the EF mode, the engine functions as a non-air hybrid split-cycle engine, operating without the use of its air reservoir. In the EF mode, a tank valve operatively connecting the crossover passage to the air reservoir remains closed to isolate the air reservoir from the basic split-cycle engine.

The split-cycle air-hybrid engine operates with the use of its air reservoir in four hybrid modes. The four hybrid modes are:
1) Air Expander (AE) mode, which includes using compressed air energy from the air reservoir without combustion;
2) Air Compressor (AC) mode, which includes storing compressed air energy into the air reservoir without combustion;
3) Air Expander and Firing (AEF) mode, which includes using compressed air energy from the air reservoir with combustion; and
4) Firing and Charging (FC) mode, which includes storing compressed air energy into the air reservoir with combustion.
   However, further optimization of these modes, EF, AE, AC, AEF and FC, is desirable to enhance efficiency and reduce emissions.

### SUMMARY OF THE INVENTION

The present invention provides a split-cycle engine in which the use of at least one of the Engine Firing (EF) mode, the Firing and Charging (FC) mode, and the Air Expander and Firing (AEF) mode is optimized for potentially any vehicle in any drive cycle for improved efficiency.

More particularly, an exemplary embodiment of an engine in accordance with the present invention includes a crankshaft rotatable about a crankshaft axis. A compression piston is slidably received within a compression cylinder and operatively connected to the crankshaft such that the compression piston reciprocates through an intake stroke and a compression stroke during a single rotation of the crankshaft. An expansion piston is slidably received within an expansion cylinder and operatively connected to the crankshaft such that the expansion piston reciprocates through an expansion stroke and an exhaust stroke during a single rotation of the crankshaft. A crossover passage interconnects the compression and expansion cylinders. The crossover passage includes a crossover expansion (XovrE) valve disposed therein. The timing of the XovrE valve closing is variable to control engine load, and the engine has a residual expansion ratio at XovrE valve closing of 14 to 1 or greater.

A method of operating an engine is also disclosed. The engine includes a crankshaft rotatable about a crankshaft axis. A compression piston is slidably received within a compression cylinder and operatively connected to the crankshaft such that the compression piston reciprocates through an intake stroke and a compression stroke during a single rotation of the crankshaft. An expansion piston is slidably received within an expansion cylinder and operatively connected to the crankshaft such that the expansion piston reciprocates through an expansion stroke and an exhaust stroke during a single rotation of the crankshaft. A crossover passage interconnects the compression and expansion cylinders. The crossover passage includes a crossover expansion (XovrE) valve disposed therein. The method in accordance with the present invention includes the following steps: controlling engine load by varying the timing of the XovrE valve closing; and maintaining a residual expansion ratio at XovrE valve closing of 14 to 1 or greater.

These and other features and advantages of the invention will be more fully understood from the following detailed description of the invention taken together with the accompanying drawings.

### BRIEF DESCRIPTION OF THE DRAWINGS

In the drawings:

FIG. 1 is a lateral sectional view of an exemplary split-cycle air-hybrid engine in accordance with the present invention;

FIG. 2 is a graphical illustration of closing angle (timing) of a crossover expansion (XovrE) valve in accordance with the present invention as a function of engine speed at various engine loads;

FIG. 3 is a graphical illustration of a preferred exemplary range of residual expansion ratio (i.e., effective volumetric expansion ratio) versus closing angle of the XovrE valve in accordance with the present invention;

FIG. 4 is a graphical illustration of compression cylinder, expansion cylinder, and crossover passage volume as a function of crank angle of the expansion piston;

FIG. 5 is a graphical illustration comparing crossover passage pressure for a fixed XovrE valve closing timing versus a variable XovrE valve closing timing as a function of engine speed and engine load; and

FIG. 6 is a graphical illustration of fuel consumption improvement for an optimized XovrE valve closing timing versus a fixed XovrE valve closing timing over a range of engine speeds and engine loads.

### DETAILED DESCRIPTION OF THE INVENTION

The following glossary of acronyms and definitions of terms used herein is provided for reference.

### In General

Unless otherwise specified, all valve opening and closing timings are measured in crank angle degrees after top dead center of the expansion piston (ATDCe).

Unless otherwise specified, all valve durations are in crank angle degrees (CA).

Air tank (or air storage tank): Storage tank for compressed air.
ATDCe: After top dead center of the expansion piston.
Bar: Unit of pressure, 1 bar=10⁵ N/m²
BMEP: Brake mean effective pressure. The term “Brake” refers to the output as delivered to the crankshaft (or output shaft), after friction losses (FMEP) are accounted for. Brake Mean Effective Pressure (BMEP) is the engine's brake torque output expressed in terms of a mean effective pressure (MEP) value. BMEP is equal to the brake torque divided by engine displacement. This is the performance parameter taken after the losses due to friction. Accordingly, BMEP=IMEP-friction. Friction, in this case is usually also expressed in terms of an MEP value known as Frictional Mean Effective Pressure (or FMEP).
Compressor: The compression cylinder and its associated compression piston of a split-cycle engine.
Effective TDC: The timing, in crank angle degrees, at which the total combined volume of the compression cylinder, expansion cylinder, and crossover passage is at a minimum.
Exhaust (or EXH) valve: Valve controlling outlet of gas from the expander cylinder.
Expander: The expansion cylinder and its associated expansion piston of a split-cycle engine.

### FMEP: Frictional Mean Effective Pressure.

IMEP: Indicated Mean Effective Pressure. The term “Indicated” refers to the output as delivered to the top of the piston, before friction losses (FMEP) are accounted for.
Inlet: Inlet valve.
Inlet valve: Valve controlling intake of gas into the compressor cylinder.
Pumping work (or pumping loss): For purposes herein, pumping work (often expressed as negative IMEP) relates to that part of engine power which is expended on the induction of the fuel and air charge into the engine and the expulsion of combustion gases.
Push-Pull method: The method of opening the crossover compression (XovrC) valve and the crossover expansion (XovrE) valve while the expansion piston is descending from TDC and the compression piston is ascending toward TDC in order to simultaneously transfer a substantially equal mass of gas into and out of the crossover passage.

### RPM: Revolutions Per Minute.

Sonic flow (velocity): Air flow in which the velocity of the air reaches the speed of sound.
Sonic flow period: A duration during which air flow into the expansion cylinder is at sonic velocity.
Sonic flow ratio: The ratio of the pressure in the crossover passage to the pressure in the expansion cylinder necessary to achieve sonic flow. For air, the sonic flow ratio is 1.894.
T junction: Junction in Xovr port for connecting to air tank.
Tank valve: Valve connecting the Xovr passage with the compressed air storage tank.
Valve duration: The interval in crank degrees between start of valve opening and end of valve closing.
VVA: Variable valve actuation. A mechanism or method operable to alter the shape or timing of a valve's lift profile.
Xovr (or Xover) valve, passage or port: The crossover valves, passages, and/or ports which connect the compression and expansion cylinders through which gas flows from compression to expansion cylinder.
XovrC (or XoverC) valves: Valves at the compressor end of the Xovr passage.
XovrE (or XoverE) valves: Valves at the expander end of the crossover (Xovr) passage.

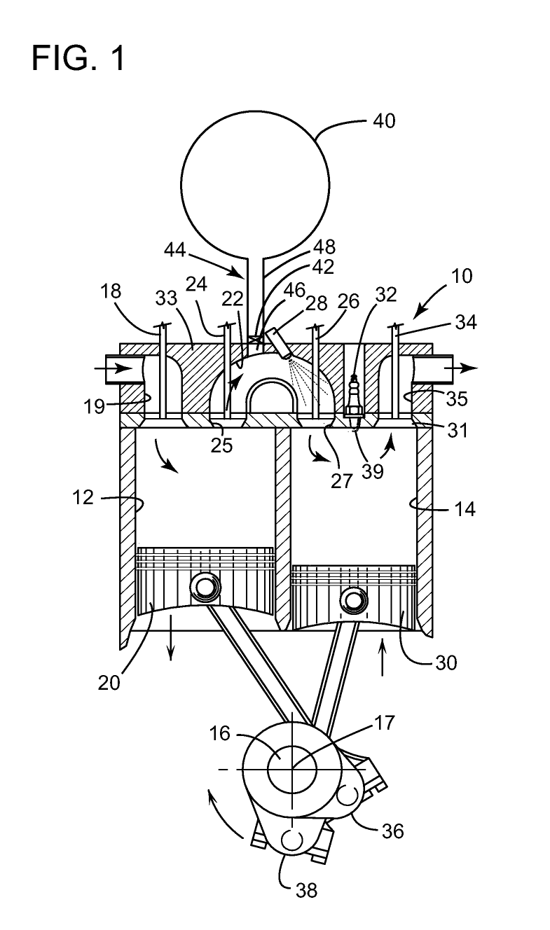

Referring to FIG. 1, an exemplary split-cycle air-hybrid engine is shown generally by numeral 10. The split-cycle air-hybrid engine 10 replaces two adjacent cylinders of a conventional engine with a combination of one compression cylinder 12 and one expansion cylinder 14. A cylinder head 33 is typically disposed over an open end of the expansion and compression cylinders 12, 14 to cover and seal the cylinders.

The four strokes of the Otto cycle are “split” over the two cylinders 12 and 14 such that the compression cylinder 12, together with its associated compression piston 20, perform the intake (or inlet) and compression strokes, and the expansion cylinder 14, together with its associated expansion piston 30, perform the expansion (or power) and exhaust strokes. The Otto cycle is therefore completed in these two cylinders 12, 14 once per crankshaft 16 revolution (360 degrees CA) about crankshaft axis 17.

During the intake stroke, intake (or inlet) air is drawn into the compression cylinder 12 through an intake port 19 disposed in the cylinder head 33. An inwardly opening (opening inwardly into the cylinder and toward the piston) poppet intake (or inlet) valve 18 controls fluid communication between the intake port 19 and the compression cylinder 12.

During the compression stroke, the compression piston 20 pressurizes the air charge and drives the air charge into the crossover passage (or port) 22, which is typically disposed in the cylinder head 33. This means that the compression cylinder 12 and compression piston 20 are a source of high-pressure gas to the crossover passage 22, which acts as the intake passage for the expansion cylinder 14. In some embodiments, two or more crossover passages interconnect the compression cylinder 12 and the expansion cylinder 14.

The geometric (or volumetric) compression ratio of the compression cylinder 12 of split-cycle engine 10 (and for split-cycle engines in general) is herein commonly referred to as the “compression ratio” of the split-cycle engine. The geometric (or volumetric) compression ratio of the expansion cylinder 14 of split-cycle engine 10 (and for split-cycle engines in general) is herein commonly referred to as the “expansion ratio” or “geometric expansion ratio” of the split-cycle engine. The geometric compression ratio of a cylinder is well known in the art as the ratio of the enclosed (or trapped) volume in the cylinder (including all recesses) when a piston reciprocating therein is at its bottom dead center (BDC) position to the enclosed volume (i.e., clearance volume) in the cylinder when said piston is at its top dead center (TDC) position. Specifically for split-cycle engines as defined herein, the compression ratio of a compression cylinder is determined when the XovrC valve is closed. Also specifically for split-cycle engines as defined herein, the expansion ratio of an expansion cylinder is determined when the XovrE valve is closed.

Due to very high compression ratios (e.g., 20 to 1, 30 to 1, 40 to 1, or greater) within the compression cylinder 12, an outwardly opening (opening outwardly away from the cylinder) poppet crossover compression (XovrC) valve 24 at the crossover passage inlet 25 is used to control flow from the compression cylinder 12 into the crossover passage 22. Due to very high expansion ratios (e.g., 20 to 1, 30 to 1, 40 to 1, or greater) within the expansion cylinder 14, an outwardly opening poppet crossover expansion (XovrE) valve 26 at the outlet 27 of the crossover passage 22 controls flow from the crossover passage 22 into the expansion cylinder 14. The actuation rates and phasing of the XovrC and XovrE valves 24, 26 are timed to maintain pressure in the crossover passage 22 at a high minimum pressure (typically 20 bar or higher at full load) during all four strokes of the Otto cycle.

At least one fuel injector 28 injects fuel into the pressurized air at the exit end of the crossover passage 22 in correspondence with the XovrE valve 26 opening, which occurs shortly before expansion piston 30 reaches its top dead center position. The air/fuel charge enters the expansion cylinder 14 when expansion piston 30 is close to its top dead center position. As piston 30 begins its descent from its top dead center position, and while the XovrE valve 26 is still open, spark plug 32, which includes a spark plug tip 39 that protrudes into cylinder 14, is fired to initiate combustion in the region around the spark plug tip 39. Combustion can be initiated while the expansion piston is between 1 and 30 degrees CA past its top dead center (TDC) position. More preferably, combustion can be initiated while the expansion piston is between 5 and degrees CA past its top dead center (TDC) position. Most preferably, combustion can be initiated while the expansion piston is between 10 and 20 degrees CA past its top dead center (TDC) position. Additionally, combustion may be initiated through other ignition devices and/or methods, such as with glow plugs, microwave ignition devices or through compression ignition methods.

During the exhaust stroke, exhaust gases are pumped out of the expansion cylinder 14 through exhaust port 35 disposed in cylinder head 33. An inwardly opening poppet exhaust valve 34, disposed in the inlet 31 of the exhaust port 35, controls fluid communication between the expansion cylinder 14 and the exhaust port 35. The exhaust valve 34 and the exhaust port 35 are separate from the crossover passage 22. That is, exhaust valve 34 and the exhaust port 35 do not make contact with, or are not disposed in, the crossover passage 22.

With the split-cycle engine concept, the geometric engine parameters (i.e., bore, stroke, connecting rod length, volumetric compression ratio, etc.) of the compression 12 and expansion 14 cylinders are generally independent from one another. For example, the crank throws 36, 38 for the compression cylinder 12 and expansion cylinder 14, respectively, may have different radii and may be phased apart from one another such that top dead center (TDC) of the expansion piston 30 occurs prior to TDC of the compression piston 20. This independence enables the split-cycle engine 10 to potentially achieve higher efficiency levels and greater torques than typical four-stroke engines.

The geometric independence of engine parameters in the split-cycle engine 10 is also one of the main reasons why pressure can be maintained in the crossover passage 22 as discussed earlier. Specifically, the expansion piston 30 reaches its top dead center position prior to the compression piston reaching its top dead center position by a discreet phase angle (typically between 10 and 30 crank angle degrees). This phase angle, together with proper timing of the XovrC valve 24 and the XovrE valve 26, enables the split-cycle engine 10 to maintain pressure in the crossover passage 22 at a high minimum pressure (typically 20 bar absolute or higher during full load operation) during all four strokes of its pressure/volume cycle. That is, the split-cycle engine 10 is operable to time the XovrC valve and the XovrE valve 26 such that the XovrC and XovrE valves are both open for a substantial period of time (or period of crankshaft rotation) during which the expansion piston 30 descends from its TDC position towards its BDC position and the compression piston 20 simultaneously ascends from its BDC position towards its TDC position. During the period of time (or crankshaft rotation) that the crossover valves 24, 26 are both open, a substantially equal mass of air is transferred (1) from the compression cylinder 12 into the crossover passage 22 and (2) from the crossover passage 22 to the expansion cylinder 14. Accordingly, during this period, the pressure in the crossover passage is prevented from dropping below a predetermined minimum pressure (typically 20, 30, or 40 bar absolute during full load operation). Moreover, during a substantial portion of the engine cycle (typically 80% of the entire engine cycle or greater), the XovrC valve 24 and XovrE valve 26 are both closed to maintain the mass of trapped gas in the crossover passage 22 at a substantially constant level. As a result, the pressure in the crossover passage 22 is maintained at a predetermined minimum pressure during all four strokes of the engine's pressure/volume cycle.

For purposes herein, the method of having the XovrC 24 and XovrE 26 valves open while the expansion piston 30 is descending from TDC and the compression piston 20 is ascending toward TDC in order to simultaneously transfer a substantially equal mass of gas into and out of the crossover passage 22 is referred to herein as the Push-Pull method of gas transfer. It is the Push-Pull method that enables the pressure in the crossover passage 22 of the split-cycle engine 10 to be maintained at typically 20 bar or higher during all four strokes of the engine's cycle when the engine is operating at full load.

As discussed earlier, the exhaust valve 34 is disposed in the exhaust port 35 of the cylinder head 33 separate from the crossover passage 22. The structural arrangement of the exhaust valve 34 not being disposed in the crossover passage 22, and therefore the exhaust port 35 not sharing any common portion with the crossover passage 22, is preferred in order to maintain the trapped mass of gas in the crossover passage 22 during the exhaust stroke. Accordingly, large cyclic drops in pressure are prevented which may force the pressure in the crossover passage below the predetermined minimum pressure.

XovrE valve 26 opens shortly before the expansion piston 30 reaches its top dead center position. At this time, the pressure ratio of the pressure in crossover passage 22 to the pressure in expansion cylinder 14 is high, due to the fact that the minimum pressure in the crossover passage is typically 20 bar absolute or higher and the pressure in the expansion cylinder during the exhaust stroke is typically about one to two bar absolute. In other words, when XovrE valve 26 opens, the pressure in crossover passage 22 is substantially higher than the pressure in expansion cylinder 14 (typically in the order of 20 to 1 or greater). This high pressure ratio causes initial flow of the air and/or fuel charge to flow into expansion cylinder 14 at high speeds. These high flow speeds can reach the speed of sound, which is referred to as sonic flow. This sonic flow is particularly advantageous to split-cycle engine 10 because it causes a rapid combustion event, which enables the split-cycle engine 10 to maintain high combustion pressures even though ignition is initiated while the expansion piston 30 is descending from its top dead center position.

The split-cycle air-hybrid engine 10 also includes an air reservoir (tank) 40, which is operatively connected to the crossover passage 22 by an air reservoir (tank) valve 42. Embodiments with two or more crossover passages 22 may include a tank valve 42 for each crossover passage 22, which connect to a common air reservoir 40, or alternatively each crossover passage 22 may operatively connect to separate air reservoirs 40.

The tank valve 42 is typically disposed in an air reservoir (tank) port 44, which extends from crossover passage 22 to the air tank 40. The air tank port 44 is divided into a first air reservoir (tank) port section 46 and a second air reservoir (tank) port section 48. The first air tank port section 46 connects the air tank valve 42 to the crossover passage 22, and the second air tank port section 48 connects the air tank valve 42 to the air tank 40. The volume of the first air tank port section 46 includes the volumes of all additional ports and recesses which connect the tank valve 42 to the crossover passage 22 when the tank valve 42 is closed.

The tank valve 42 may be any suitable valve device or system. For example, the tank valve 42 may be an active valve which is activated by various valve actuation devices (e.g., pneumatic, hydraulic, cam, electric or the like). Additionally, the tank valve 42 may comprise a tank valve system with two or more valves actuated with two or more actuation devices.

Air tank 40 is utilized to store energy in the form of compressed air and to later use that compressed air to power the crankshaft 16, as described in the aforementioned U.S. Pat. No. 7,353,786 to Scuderi et al. This mechanical means for storing potential energy provides numerous potential advantages over the current state of the art. For instance, the split-cycle engine 10 can potentially provide many advantages in fuel efficiency gains and NOx emissions reduction at relatively low manufacturing and waste disposal costs in relation to other technologies on the market, such as diesel engines and electric-hybrid systems.

By selectively controlling the opening and/or closing of the air tank valve 42 and thereby controlling communication of the air tank 40 with the crossover passage 22, the split-cycle air-hybrid engine 10 is operable in an Engine Firing (EF) mode, an Air Expander (AE) mode, an Air Compressor (AC) mode, an Air Expander and Firing (AEF) mode, and a Firing and Charging (FC) mode. The EF mode is a non-hybrid mode in which the engine operates as described above without the use of the air tank 40. The AC and FC modes are energy storage modes. The AC mode is an air-hybrid operating mode in which compressed air is stored in the air tank 40 without combustion occurring in the expansion cylinder 14 (i.e., no fuel expenditure), such as by utilizing the kinetic energy of a vehicle including the engine 10 during braking. The FC mode is an air-hybrid operating mode in which excess compressed air not needed for combustion is stored in the air tank 40, such as at less than full engine load (e.g., engine idle, vehicle cruising at constant speed). The storage of compressed air in the FC mode has an energy cost (penalty); therefore, it is desirable to have a net gain when the compressed air is used at a later time. The AE and AEF modes are stored energy usage modes. The AE mode is an air-hybrid operating mode in which compressed air stored in the air tank 40 is used to drive the expansion piston 30 without combustion occurring in the expansion cylinder 14 (i.e., no fuel expenditure). The AEF mode is an air-hybrid operating mode in which compressed air stored in the air tank 40 is utilized in the expansion cylinder 14 for combustion.

In the EF mode, the compression piston 20 draws in and compresses inlet air for use in the expansion cylinder 14. The compressed air from the compression cylinder 12 is admitted to the expansion cylinder 14 with fuel, at the beginning of an expansion stroke, which is ignited, burned and expanded on the same expansion stroke of the expansion piston 30, transmitting power to the crankshaft 16, and the combustion products are discharged on the exhaust stroke. Since compressed air is neither stored in nor released from the air tank 40 in the EF mode, the air tank valve 42 is closed.

In the FC mode, the compression piston 20 draws in and compresses inlet air for use in the expansion cylinder 14 during a single rotation of the crankshaft 16. Some of the compressed air from the compression cylinder 12 is admitted to the expansion cylinder 14 with fuel, at the beginning of an expansion stroke, which is ignited, burned and expanded on the same expansion stroke of the expansion piston, transmitting power to the crankshaft, and the combustion products are discharged on the exhaust stroke. The air tank 40 is also charged with compressed air during the same single rotation of the crankshaft 16 by selectively opening and then closing the air tank valve 42.

In the AEF mode, compressed air stored in the air tank 40 is admitted to the expansion cylinder 14 with fuel, at the beginning of an expansion stroke, by keeping the air tank valve 42 open for at least a portion of the crankshaft rotation. The air/fuel mixture is ignited, burned and expanded on the same expansion stroke of the expansion piston 30, transmitting power to the crankshaft 16, and the combustion products are discharged on the exhaust stroke.

In the AE mode, compressed air stored in the air tank 40 is admitted to the expansion cylinder 14, at the beginning of an expansion stroke. Since in this mode the air tank valve 42 is kept open for at least a portion of the crankshaft rotation, air flow into the expansion cylinder 14 is controlled by the XovrE valve 26. The air is expanded on the same expansion stroke of the expansion piston 30, transmitting power to the crankshaft 16, and the (expanded) air is discharged on the exhaust stroke.

The XovrE valve 26 may be a variably actuatable valve capable of variable valve actuation (VVA) such that the opening and/or closing timings (in crank angle degrees) of the XovrE valve may be varied from one engine cycle to another. In at least one of the EF mode, the FC mode, the AE mode, and the AEF mode, the timing of the XovrE valve closing is varied to control engine load (typically expressed as torque in units of NM or as IMEP or BMEP in units of Bar). That is, during at least one of the EF mode, the FC mode, the AE mode, and the AEF mode, the XovrE valve closing timing is varied from at least a first cycle of the engine's 10 operation to a second cycle of the engine's 10 operation to provide a first mass of air required to produce a first torque at the first cycle and a second mass of air required to produce a second torque at the second cycle.

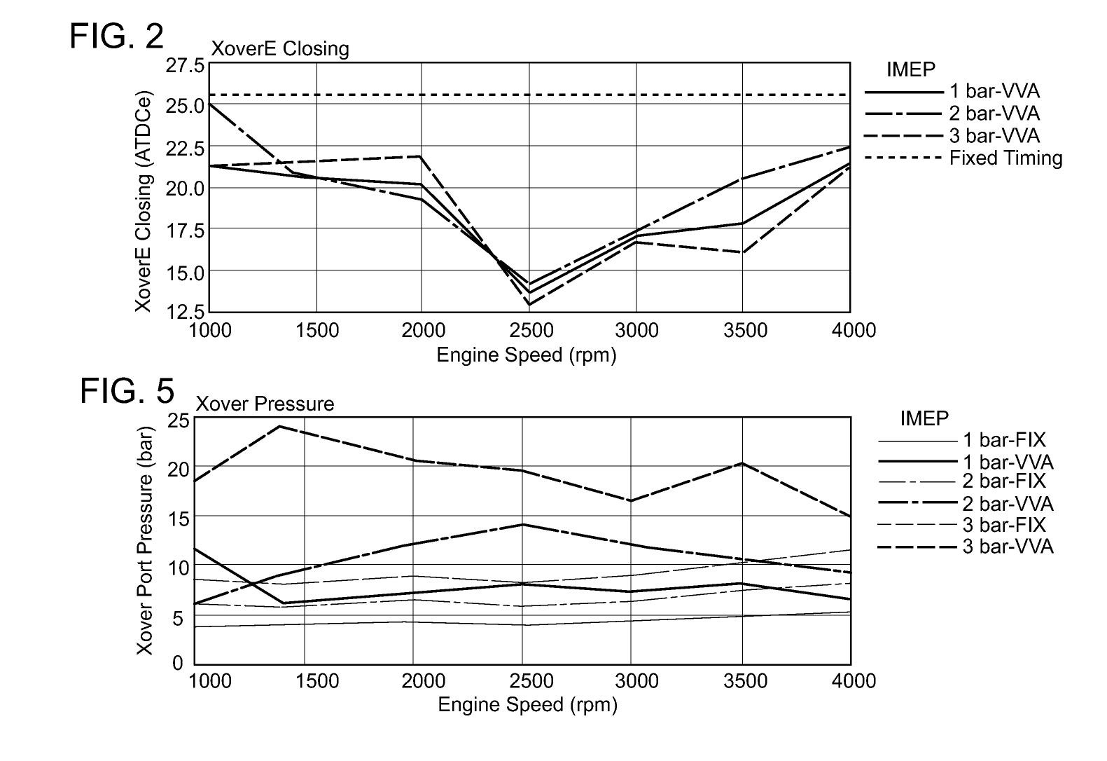

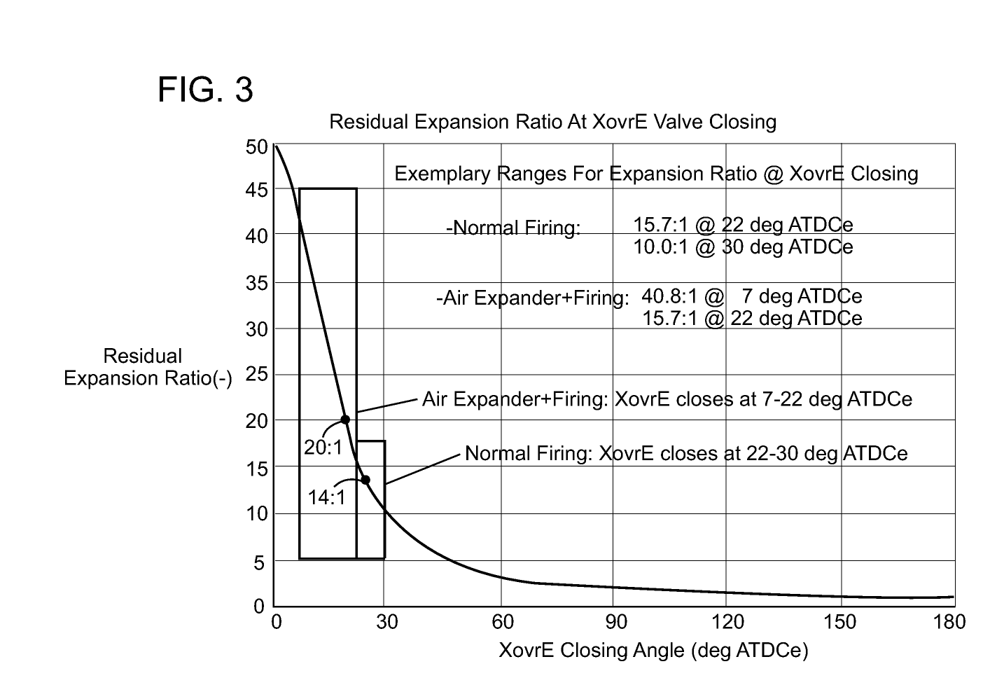

Moreover, the XovrE valve 26 closing timing may be varied to meter into, and trap in, the expansion cylinder 14 the necessary mass of air to produce a required amount of torque for any cycle of engine 10 operation during any of the EF, FC, AE and AEF modes of operation. The required torque can be produced by combining the metered air with the required amount of fuel to be ignited, burned, and expanded during a combustion event as in the EF, FC, and AEF modes. Alternatively, the required torque can be produced by metering just air into the expansion cylinder to be expanded during the AE mode. As shown by example in FIGS. 2 and 3, in the EF and AEF modes the XovrE valve 26 should preferably be closed at least 30 degrees or less ATDCe, more preferably should be closed at approximately 27 degrees or less ATDCe, and even more preferably should be closed at approximately 22 degrees or less ATDCe as it meters air into the expansion cylinder to control load. However, the ranges shown in FIG. 2 are only one exemplary embodiment specific to the EF mode, and other embodiments and other engine modes may have other ranges of XovrE valve 26 closing. Also, the ranges shown in FIG. 2 are dependent upon engine load. For example, at an engine load of 2 bar IMEP, the XovrE valve 26 should be closed at approximately 25 degrees or less ATDCe, whereas at an engine load of 3 bar IMEP, the XovrE valve 26 should be closed at approximately 22 degrees or less ATDCe.

Further, as shown by example within the EF and AEF ranges depicted in FIG. 3, the engine 10 in accordance with the present invention has a residual expansion ratio at XovrE valve 26 closing of approximately 10 to 1 or greater during a majority of its operating range, preferably has a residual expansion ratio of approximately 14 to 1 or greater, more preferably has a residual expansion ratio of 15.7 to 1 or greater, and most preferably has a residual expansion ratio of approximately 20 to 1 or greater. The earlier (ATDCe) that the XovrE valve 26 closes, the greater the residual expansion ratio, which is defined as the ratio (a/b) of (a) the trapped volume in the expansion cylinder 14 (i.e., the volume of a chamber generally defined by the cylinder 14 wall, the top of the expansion piston 30, and the bottom of the cylinder head 33) when the expansion piston 30 is at bottom dead center to (b) the trapped volume in the expansion cylinder 14 at the time just when the XovrE valve 26 closes. Once the XovrE valve 26 is closed during the expansion stroke of the expansion piston 30, the expanding trapped mass is present solely in the expansion cylinder 14 and work is produced as the mass expands. Clearly, the earlier the XovrE valve 26 closes, the closer the expansion piston 30 is to top dead center, thus the greater the residual expansion ratio and the more work that is produced during the expansion stroke.

A high residual expansion ratio results when engine load is controlled with the XovrE valve because the charge air entering the expansion cylinder 12 is at sonic velocity during most of the engine operating conditions. Due to the high velocity of the air flowing into the expansion cylinder 12, the XovrE valve 26 must close quickly after top dead center of the expansion piston 30 in order to meter into, and trap in, the expansion cylinder 14 the necessary mass of air to produce a given torque during a given operating cycle. As discussed above, the earlier (i.e., quicker) the XovrE valve 26 closes, the higher the residual expansion ratio, which, in the case of the present invention is typically 10 to 1 or greater, and preferably 14 to 1 or greater.

Sonic velocity of the air entering the expansion cylinder 14 when the XovrE valve 26 is initially opened is achieved by maintaining the pressure in the crossover passage 22 at more than 1.894 the pressure in the expansion cylinder during the exhaust stroke (i.e., above the sonic pressure ratio for air). In the EF and FC modes of the engine, a high pressure in the crossover passage 22 is maintained by utilizing the Push-Pull method of gas transfer described above. In the AEF mode as well as the AE mode, a high pressure in the crossover passage 22 is maintained by keeping the air tank 40 pressure at or above 5 bar, preferably above 7 bar, and more preferably above 10 bar.

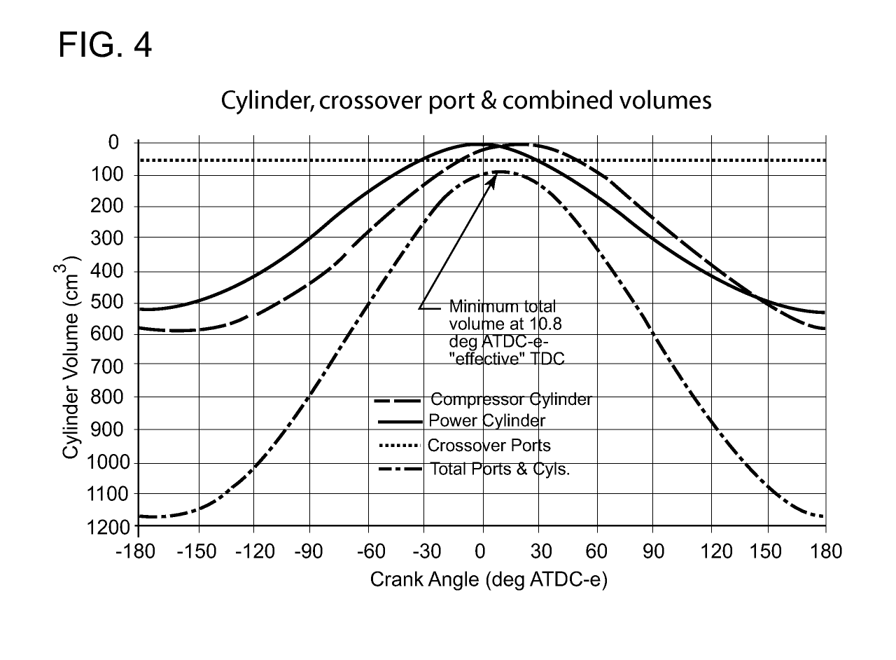

Further, in order to maintain the pressure of the air travelling through the crossover passage 22 from the compression cylinder 12 to the expansion cylinder 14 at a high pressure, the volume of the crossover passage must be small compared to the total volume of the compression and expansion cylinders 12, (“total cylinder volume”) when the respective compression and expansion pistons 20, 30 are at bottom dead center (BDC). The total cylinder volume is significant because in the Push-Pull method, both the XovrC valve 24 and XovrE valve 26 are open when a mass of air is transferred through the crossover passage 22. Hence, the volume of both the compression cylinder 12 and expansion cylinder 14 are simultaneously in communication with the crossover passage 22 during the Push-Pull method. As shown in FIG. 4, in an exemplary embodiment of the split-cycle engine 10, the maximum expansion cylinder 14 volume (at BDC of the expansion piston 30) is greater than 510 cubic centimeters (cc), the maximum compression cylinder 12 volume (at BDC of the compression piston 20) is greater than 570 cc, the total crossover passage 22 volume is constant at less than 70 cc, and the maximum total cylinder volume (i.e., the expansion cylinder 14 volume at BDC plus the compression cylinder 12 volume at BDC) is greater than 1080 cc. Therefore, in order to maintain a high pressure in the crossover passage 22, the total cylinder volume should be at least 8 times greater than the volume of the crossover passage 22, preferably at least 10 times greater than the volume of the crossover passage, and more preferably at least 15 times greater than the volume of the crossover passage.

Additionally, as shown in FIG. 4, in order to maintain a high pressure in the crossover passage 22, the maximum compression cylinder 12 volume (at bottom dead center of the compression piston 20) should be at least 2 times greater than the volume of the crossover passage 22, preferably at least 4 times greater than the volume of the crossover passage, more preferably at least 6 times greater than the volume of the crossover passage, and most preferably at least 8 times greater than the volume of the crossover passage. Further, in order to maintain a high pressure in the crossover passage 22, the maximum expansion cylinder 14 volume (at bottom dead center of the expansion piston 30) should be at least times greater than the volume of the crossover passage 22, preferably at least 4 times greater than the volume of the crossover passage, and more preferably at least 6 times greater than the volume of the crossover passage.

Also, in order to maintain a high pressure in the crossover passage 22, the minimum total volume of the compression cylinder 12, expansion cylinder 14, and crossover passage 22 at “effective” TDC (i.e., the timing, in crank angle degrees, at which the total combined volume of the compression cylinder, expansion cylinder, and crossover passage is at a minimum) should be less than 4 times the total volume of the crossover passage, preferably less than 3 times the volume of the crossover passage, and more preferably less than 2 times the volume of the crossover passage. For instance, in the exemplary embodiment of FIG. 4, the crossover passage has a constant total volume of approximately 62 cc and the minimum total volume at “effective” TDC (which in this case occurs at 10.8 degrees ATDCe) is approximately 100 cc. The minimum total volume at “effective” TDC is close to the fixed volume of the crossover passage 22 because at actual top dead center of the compression and expansion pistons 20, 30, the volumes of the compression and expansion cylinders 12, 14 are very small. In other words, the geometric compression ratio of the compression cylinder 12 is approximately 95:1 and the geometric expansion ratio of the expansion cylinder 14 is approximately 50:1, meaning that there is a small, tight clearance between the compression and expansion pistons 20, 30 and the cylinder head 33 (specifically, the fire deck of the head) at the pistons' 20, 30 respective top dead center positions.

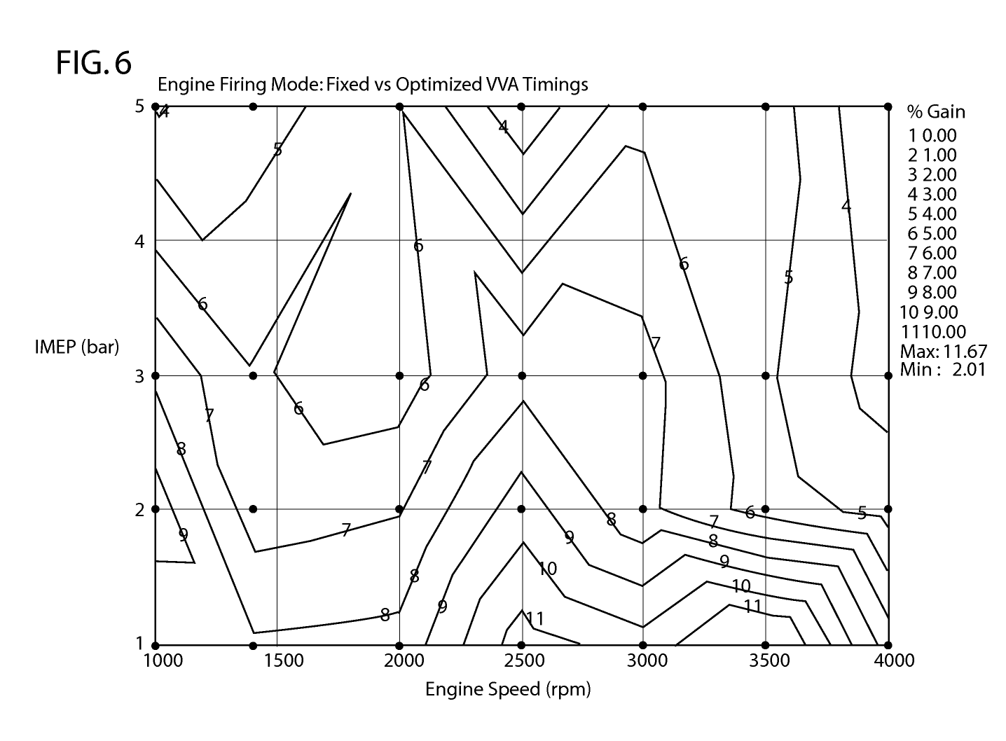

Varying the timing of the XovrE valve 26 closing to control engine load results in a higher crossover passage 22 pressure in comparison to operating with a fixed XovrE valve closing timing. As shown by example in FIG. 5, in the EF mode, at any given engine load the pressure in the crossover passage 22 is higher when VVA is used for the XovrE valve 26 rather than a fixed valve timing actuation arrangement. For example, at an engine speed of 2500 rpm and an engine load of 2 bar IMEP, the crossover passage 22 pressure is approximately 6 bar when the XovrE valve 26 closing angle (timing) is fixed, whereas it is approximately 13 bar when the XovrE valve closing angle is variable.

The increase in crossover passage 22 pressure results in an increase in the sonic flow period of the mass of air that enters the expansion cylinder 14, thereby increasing the efficiency of the engine 10. As shown by example in FIG. 6, in the EF mode, approximately a 1 to 10% gain in fuel efficiency is achieved when the XovrE valve 26 closing timing is variable and optimized as compared to when the XovrE valve 26 closing timing is fixed.

Although the invention has been described by reference to a specific embodiment, it should be understood that numerous changes may be made within the spirit and scope of the inventive concepts described. Accordingly, it is intended that the invention not be limited to the described embodiment, but that it have the full scope defined by the language of the following claims.

What is claimed is:

1. An engine comprising:
a crankshaft rotatable about a crankshaft axis;
a compression piston slidably received within a compression cylinder and operatively connected to the crankshaft such that the compression piston reciprocates through an intake stroke and a compression stroke during a single rotation of the crankshaft;
an expansion piston slidably received within an expansion cylinder and operatively connected to the crankshaft such that the expansion piston reciprocates through an expansion stroke and an exhaust stroke during a single rotation of the crankshaft; and
a crossover passage interconnecting the compression and expansion cylinders, the crossover passage including a crossover expansion (XovrE) valve disposed therein;
wherein the timing of the XovrE valve closing is variable to control engine load, and the engine has a residual expansion ratio at XovrE valve closing of 14 to 1 or greater.

2. The engine of claim 1, wherein the residual expansion ratio at XovrE valve closing is 20 to 1 or greater.

3. The engine of claim 1, wherein the XovrE valve is closed at approximately 27 degrees or less after top dead center of the expansion piston (ATDCe).

4. The engine of claim 1, wherein the XovrE valve is an outwardly opening valve.

5. The engine of claim 1, wherein the XovrE valve is a variably actuatable valve capable of variable valve actuation (VVA).

6. The engine of claim 1, wherein the total combined volume of the compression and expansion cylinders is at least 8 times greater than the volume of the crossover passage.

7. The engine of claim 1, wherein the total volume of the compression cylinder is at least 2 times greater than the volume of the crossover passage.

8. The engine of claim 1, wherein the total volume of the expansion cylinder is at least 2 times greater than the volume of the crossover passage.

9. The engine of claim 1, wherein the minimum total volume of the compression cylinder, expansion cylinder, and crossover passage at effective top dead center is less than 4 times the volume of the crossover passage.

10. The engine of claim 1, wherein:
the crossover passage includes a crossover compression (XovrC) valve disposed therein, the crossover compression (XovrC) valve and the crossover expansion (XovrE) valve defining a pressure chamber therebetween;
an air reservoir is operatively connected to the crossover passage via an air reservoir port and selectively operable to store compressed air from the compression cylinder and to deliver compressed air to the expansion cylinder; and
an air reservoir valve selectively controls air flow into and out of the air reservoir.

11. The engine of claim 10, wherein the engine is operable in an Engine Firing (EF) mode, wherein, in the EF mode, the air reservoir valve is kept closed, the compression piston draws in and compresses inlet air for use in the expansion cylinder, and compressed air is admitted to the expansion cylinder with fuel, at the beginning of an expansion stroke, which is ignited, burned and expanded on the same expansion stroke of the expansion piston, transmitting power to the crankshaft, and the combustion products are discharged on the exhaust stroke.

12. The engine of claim 10, wherein the engine is operable in a Firing and Charging (FC) mode, and in the FC mode, the air reservoir valve is selectively opened and closed, the compression piston draws in and compresses inlet air for use in the expansion cylinder during a single rotation of the crankshaft, and compressed air is admitted to the expansion cylinder with fuel, at the beginning of an expansion stroke, which is ignited, burned and expanded on the same expansion stroke of the expansion piston, transmitting power to the crankshaft, and the combustion products are discharged on the exhaust stroke, and the air reservoir is charged with compressed air during the same single rotation of the crankshaft.

13. The engine of claim 10, wherein the engine is operable in an Air Expander and Firing (AEF) mode, and in the AEF mode, the air reservoir valve is kept open, compressed air from the air reservoir is admitted to the expansion cylinder with fuel, at the beginning of an expansion stroke, which is ignited, burned and expanded on the same expansion stroke of the expansion piston, transmitting power to the crankshaft, and the combustion products are discharged on the exhaust stroke.

14. A method of operating an engine including:
a crankshaft rotatable about a crankshaft axis;
a compression piston slidably received within a compression cylinder and operatively connected to the crankshaft such that the compression piston reciprocates through an intake stroke and a compression stroke during a single rotation of the crankshaft;
an expansion piston slidably received within an expansion cylinder and operatively connected to the crankshaft such that the expansion piston reciprocates through an expansion stroke and an exhaust stroke during a single rotation of the crankshaft; and
a crossover passage interconnecting the compression and expansion cylinders, the crossover passage including a crossover expansion (XovrE) valve disposed therein;
the method including the steps of:
controlling engine load by varying the timing of the XovrE valve closing; and
maintaining a residual expansion ratio at XovrE valve closing of 14 to 1 or greater.

15. The method of claim 14, including the step of maintaining the residual expansion ratio at XovrE valve closing at 20 to 1 or greater.

16. The method of claim 14, including the step of closing the XovrE valve at approximately 27 degrees or less after top dead center of the expansion piston (ATDCe).

17. The method of claim 14, wherein the engine includes a crossover compression (XovrC) valve disposed in the crossover passage, the crossover compression (XovrC) valve and the crossover expansion (XovrE) valve defining a pressure chamber therebetween, an air reservoir operatively connected to the crossover passage via an air reservoir port and selectively operable to store compressed air from the compression cylinder and to deliver compressed air to the expansion cylinder, and an air reservoir valve selectively controlling air flow into and out of the air reservoir.

18. The method of claim 17, including the steps of:
operating the engine in an Engine Firing (EF) mode;
keeping the air reservoir valve closed;
drawing in and compressing inlet air with the compression piston; and
admitting compressed air from the compression cylinder into the expansion cylinder with fuel, at the beginning of an expansion stroke, the fuel being ignited, burned and expanded on the same expansion stroke of the expansion piston, transmitting power to the crankshaft, and the combustion products being discharged on the exhaust stroke.

19. The method of claim 17, including the steps of:
operating the engine in a Firing and Charging (FC) mode;
drawing in and compressing inlet air with the compression piston during a single rotation of the crankshaft;
admitting compressed air into the expansion cylinder with fuel, at the beginning of an expansion stroke, the fuel being ignited, burned and expanded on the same expansion stroke of the expansion piston, transmitting power to the crankshaft, and discharging the combustion products on the exhaust stroke; and
charging the air reservoir with compressed air during the said single rotation of the crankshaft.

20. The method of claim 17, including the steps of:
operating the engine in an Air Expander and Firing (AEF) mode; and
admitting compressed air from the air reservoir into the expansion cylinder with fuel, at the beginning of an expansion stroke, which is ignited, burned and expanded on the same expansion stroke of the expansion piston, transmitting power to the crankshaft, and discharging the combustion products on the exhaust stroke.

21. An engine comprising:
a crankshaft rotatable about a crankshaft axis;
a compression piston slidably received within a compression cylinder and operatively connected to the crankshaft such that the compression piston reciprocates through an intake stroke and a compression stroke during a single rotation of the crankshaft;
an expansion piston slidably received within an expansion cylinder and operatively connected to the crankshaft such that the expansion piston reciprocates through an expansion stroke and an exhaust stroke during a single rotation of the crankshaft; and
a crossover passage interconnecting the compression and expansion cylinders, the crossover passage including a crossover compression (XovrC) valve and a crossover expansion (XovrE) valve defining a pressure chamber therebetween;
wherein the timing of the XovrE valve closing is variable to control engine load, the total combined volume of the compression and expansion cylinders is at least 8 times greater than the volume of the crossover passage, and the minimum total volume of the compression cylinder, expansion cylinder, and crossover passage at effective top dead center is less than 4 times the volume of the crossover passage.

22. The engine of claim 21 comprising:
the XovrE valve closing timing being operable to vary from a first cycle of the engine's operation to a second cycle of the engine's operation to provide a first mass of air required to produce a first torque at the first cycle and a second mass of air required to produce a second torque at the second cycle.

23. The engine of claim 22, wherein:
the crossover passage includes a crossover compression (XovrC) valve disposed therein, the crossover compression (XovrC) valve and the crossover expansion (XovrE) valve defining a pressure chamber therebetween;
an air reservoir is operatively connected to the crossover passage via an air reservoir port and selectively operable to store compressed air from the compression cylinder and to deliver compressed air to the expansion cylinder;
an air reservoir valve selectively controls air flow into and out of the air reservoir;
the engine being operable in any one of an EF mode, an FC mode, an AE mode, and an AEF mode; and
the XovrE valve closing timing being varied to meter into, and trap in, the expansion cylinder a mass of air to produce a required amount of torque for a cycle of engine operation during at least one of the EF, FC, AE, and AEF modes.

24. The engine of claim 23, wherein the XovrE valve closing timing is varied to meter into, and trap in, the expansion cylinder a mass of air to produce a required amount of torque for a cycle of engine operation during each of the EF, FC, AE, and AEF modes.

25. The engine of claim 22, wherein the total volume of the compression cylinder is at least 2 times greater than the volume of the crossover passage.

26. The engine of claim 22, wherein the total volume of the expansion cylinder is at least 2 times greater than the volume of the crossover passage.
